(19) United States
(12) Patent Application Publication
(10) Pub. No.: US 2003/0207951 A1
(43) Pub. Date: Nov. 6, 2003

(54) Hydroxilated adhesive composition and process for making the same

(76) Inventor: Joel da Silva Calhau, Sao Paulo (BR)

Correspondence Address: MERCHANT & GOULD PC, P.O. BOX 2903, MINNEAPOLIS, MN, 55402-0903, US

(21) Appl. No.: 09/909,583

(22) Filed: Jul. 20, 2001

(30) Foreign Application Priority Data
Sep. 1, 2000 (BR) PI 0003967-5

(51) Int. Cl. C08J 11/04

(52) U.S. Cl. 521/48

(57) ABSTRACT

The present invention refers to the production of a line of liquid adhesives using as raw material ground, crushed or in any physical form PET bottles, reclaimed polyethylene terephthalate (PET) scrap of any kind and/or species and/or physical form, distillation residues from polyethylene terephthalate polimerization (oligomer solution), dicyclopentadiene, naphta (petroleum) cracking and distillation byproducts.

### FIELD OF THE INVENTION

The present invention refers to the production of a series of liquid adhesives using as raw material ground, crushed or in any other physical form of PET bottles, reclaimed polyethylene terephthalate (PET) scrap of any kind and/or species and/or physical form, distillation residues from polyethylene terephthalate polimerization (oligomer solution), dicyclopentadiene, naphta (petroleum) cracking and distillation byproducts.

Such adhesive has been developed by exclusive technology in order to meet the demand for flexible packages and reinforced plastic by means of reclaiming polyethylene terephthalate (PET) scrap of any kind and/or species and/or physical form, as well as distillation residues from polyethylene terephthalate polimerization (oligomer solution), dicyclopentadiene, naphta (petroleum) cracking and distillation byproducts.

### SUMMARY OF THE INVENTION

The present invention refers to a hydroxylated adhesive for the flexible packages rolling section and for the reinforced plastic market (with fiberglass or mineral fillers), whose scientific name is Hydroxylated Adhesive, and the trade name Adecrom, Resicrom or Uvecrom.

Hydroxylated adhesives present agglomerating and structural properties and are obtained from terephthalic bases, glycols and acids polimerization, and may undergo urethanization and acrylation complementary reactions.

The function of such products is to stick plastic films or reinforced plastic, or fillers (fiberglass, mineral fillers and the like) to a thermoset polymer, during the film rolling process or the polimerization of a polymeric matrix with fillers.

The hydroxylated adhesive provides adhesion of the substrates (fillers) to the polymeric matrix, in products having mineral fillers and/or fiberglass resulting in increasing the heat distortion temperature, elasticity modulus and flexing, improves resistance to hydrolysis, solvents, detergents, soaps and other chemical products, fundamental properties to increase the reinforced plastic's shelf life.

The product will be acquired from package manufacturers in general and fiberglass and/or mineral fillers reinforced plastic piece manufacturers.

Although the hydroxylated adhesives of the state of the art meet market requirements, a hydroxylated adhesive has been developed using as one of the raw materials ground, crushed or in any physical form PET bottles, reclaimed polyethylene terephthalate (PET) scrap of any kind and/or species and/or physical form, distillation residues from polyethylene terephthalate polimerization (oligomer solution), dicyclopentadiene, naphta (petroleum) cracking and distillation byproducts, having agglomerating, structural and adhesivity characteristics.

The adhesive will be marketed in liquid form, being diluted in solvents or reactive monomers, or even concentrated, packaged in 220-kg drums for liquids, having a shelf life of 90 days under a maximum temperature of 30° C.

### DETAILED DESCRIPTION OF THE INVENTION

The present invention refers to the production of a line of liquid adhesives using as raw material ground, crushed or in any physical form PET bottles, reclaimed polyethylene terephthalate (PET) scrap of any kind and/or species and/or physical form, distillation residues from polyethylene terephthalate polimerization (oligomer solution), dicyclopentadiene, naphta (petroleum) cracking and distillation byproducts.

Such adhesive has been developed by exclusive technology in order to meet a flexible packages and reinforced plastic market need by means of reclaiming polyethylene terephthalate (PET) scrap of any kind and/or species and/or physical form, distillation residues from polyethylene terephthalate polimerization (oligomer solution), dicyclopentadiene, naphta (petroleum) cracking and distillation byproducts.

The process for obtaining the hydroxylated adhesive of the present invention consists of reacting a terephthalic base (A) and, in any mixing proportion, alcohol bases (B) and acids (C), controlling the reaction process by monitoring the terminal hydroxyl variation within the range of 10 to 1,000 mg KOH/g, according to the application requirements.

The hydroxylated adhesive may undergo dilutions with reactive or non-reactive solvents, or even undergo urethanization and acrylation complementary reactions.

The basic raw materials used in developing and producing the hydroxylated adhesive are: a terephthalic base having terephthalic groups or pentadienic groups, alcohol base having functional hydroxyl groups, acid base having functional carboxyl groups, isocyanate base having functional isocyanate groups, acylated base having functional acrylic groups or acrylate groups, reactive and non reactive solvent base, according to the examples below:

A: Terephthalic Base
Ground polyethylene terephthalate (PET) bottle.
Poly (ethylene terephatalate)
Polyethylene terephthalate (PET) scrap of any kind
and/or species and/or physical form
Distillation residues from polyethylene terephthalate
polimerization (oligomer solution)
Dicyclopentadiene, naphta (petroleum) cracking and
distillation byproducts
B: Alcohol Base
Ethyleneglycol
Diethyleneglycol
Propyleneglycol
1,3-Butanediol
Neopentylglycol
Hexyleneglycol
Trimethylolpropane
Trimethylolethane
C: Acid Base
Fumaric acid
Adipic acid
Maleic acid
Terephthalic acid
Isophthalic acid
Phthalic anhydride
Tetrahydrophthalic anhydride
Trimethylic anhydride
D: Isocyanate Base
Diphenylmethane diisocyanate (MDI)
Tolylene diisocyanate (TDI 80/20)
Isophorone diisocyanate (IPDI)
E: Acrylated Base
Hydroxyethyl acrylate
Tripropyleneglycol diacrylate
Trimethylolpropane triacrylate
1,6-Hexamethyleneglycol diacrylate
Acrylic acid
F: Reactive Solvent Base
Styrene monomer
Butyl acrylate
Methyl methacrylate
G: Non Reactive Solvent Base
Methyl ethyl ketone
Ethyl acetate
Ethylic alcohol
Hexana

The items of tables E, F and G are used only to correct viscosity (flowability) by means of physical blends, except acrylic acid, which is used by means of a polimerization reaction process and the solvent amount depends on the application.

The following example shows a basic formulation, among the many possible ones, for producing a 100% solid HYDROXYLATED ADHESIVE (without dilution):

A—55.49 g of terephthalic base

B—18.48 g of alcohol base

C—26.03 g of acid base

The hydroxylated adhesive, prepared according to the above specifications, may undergo changes by urethanization and/or acrylation in relation to the composition's total weight.

The invention further refers to a process for obtaining an adhesive, which consists of polimerization steps in order to obtain a hydroxylated adhesive having terminal hydroxyls within the range of 10 to 1,000 mg KOH/g.

The following example shows the steps of polimerization in general: a flask and/or reactor is charged with 55.49 grams of terephthalic base (A) plus 18.48 grams of alcohol base (B), heating the mass at a temperature of 120 to 280° C., under pressure or not, keeping the mixture under agitation for 2 to 10 hours for a complete solid portions homogenization (melting).

After melting A+B, the terminal hydroxyls adjustment process is started, adding item C, keeping the temperature between 100 and 260° C.

After adjusting the terminal hydroxyls, which should be within 10 and 1,000 mg KOH/g, according to the application requirements, the melted mass is cooled to 100 to 220° C.

The molecular weight of the adhesive may vary around 3,000.

In this phase, the adhesive is able to undergo the following final adjustments, according to the specific application thereof:

a) cooling and discharging for use as solventless adhesive (100% solid) for flexible packages rolling;

b) diluting in non-reactive solvents up to 60% solids for flexible packages rolling;

c) additivating and diluting with reactive solvents up to 60% solids for application as fiberglass or mineral fillers reinforced plastic;

d) additivating and diluting with acrylated base up to 60% solids for applications using ultraviolet radiation;

e) receiving pigments of any chemical type or color for specific applications. For example: titanium dioxide, organic or inorganic pigments, or blends in paste form;

f) undergoing complementary reactions in order to meet specific applications, not characterizing another product or new technology, being thus comprised in this patent application, such as, for example, urethanization and/or acrylation and vice-versa.

Urethanization:

Urethanization consists of adding to the hydroxylated adhesive an isocyanate base, by chemical reaction, or physical incorporation, or a mixture of such isocyanate base, or urethane prepolymers, or blends of such products in any proportion, in order to adjust terminal hydroxyls. Urethanization improves the substrate's adhesivity to a thermoset matrix in fiberglass or mineral fillers reinforced plastic applications, or mixtures of any product, in order to reinforce the polymeric matrix after curing.

The following example shows a basic formulation, among the many possible ones, used for URETHANIZING THE HYDROXYLATED ADHESIVE:

X—560 g of hydroxylated adhesive

D—17 g of isocyanate base

E—solvents

Item D is added in order to urethanize the hydroxylated adhesive, controlling the temperature and/or exothermicity in order not to exceed 90° C. After exothermicity, the adhesive is heated between 45° C. and 170° C. and the NCO content is controlled every 2 hours. When the NCO (isocyanate) content is zero, there occurred 100% urethanization, forming the urethanized hydroxylated adhesive. Urethanization has the sole purpose of improving the substrate's adhesivity to a thermoset matrix by urethane polar groups, resulting in improved physical-chemical properties.

After urethanization, viscosity is adjusted with item E, F or G, according to the application requirements.

Acrylation:

Acrylation consists of adding to the hydroxylated adhesive acrylic or acrylated functional monomers, by means of chemical reaction or physical incorporation of any other acrylic product in order to use the hydroxylated adhesive in the line of adhesives, varnishes and paints for curing with ultraviolet, infrared, electron beam radiation, mixed, blended or reacted with butyl acrylate, hydroxyethyl acrilate, tripropylene glycol diacrylate, trimethylolpropane triacrylate and the like.

The following example shows a basic formulation, among the many possible ones, used for ACRYLATING THE HYDROXYLATED ADHESIVE:

X—560 g of hydroxylated adhesive

E—14 g of acrylated base

Item E is added in order to acrylate the hydroxylated adhesive, controlling the temperature and/or exothermicity in order not to exceed 180° C. After exothermicity, keep the reaction up to when about 98% theoretical water is removed from the system, forming the acrylated hydroxylated adhesive. Acrylation is performed in order to allow the adhesive to undergo a curing reaction by means of ultraviolet radiation or electron beam.

After acrylation, viscosity is adjusted with item E or F, according to the specific application.

Application 1) The hydroxylated adhesive may be used to stick flexible plastic films for packages in general, having as co-reactant or catalyst a urethane or epoxy prepolymer, with or without a solvent, having or not an accelerator, a reaction retarder, an antioxidant or other polymer additives, alone or mixed in any proportion.

Examples: toluene trimethylpropane diisocyanate adduct, trade name of Brampac S.A. Alcrom 10702 or Alcrom 10780, epoxy resin trade name of Brampac S.A. Resicrom 1045.

2) The hydroxylated adhesive may be used to stick reinforced plastic or adhering fiberglass, mineral fillers or any other reinforcement in general to the thermoset polymeric matrix by means of physical blends of 30% to 70% by weight, before curing or hardening the resin, having as co-reactant or catalyst organic peroxides, with or without a solvent, having or not an accelerator, a reaction retarder, inhibitors, antioxidants, antiflame additives or other products for use as polymer additives, used alone or in blends in any proportion.

Examples: methyl ethyl ketone peroxide, benzoyl peroxide, tert-butyl perbenzoate, acetyl acetone peroxide, azo-bis isobutyronitrile and the like.

3) The hydroxylated adhesive may be used in adhesives, paints, varnishes, gel coat and other products curable by ultraviolet, infrared, electron beam radiation, having as co-reactant or catalyst substances designed by photoinitiators, that is, light sensible chemical products (photosensible).

Examples: benzylic acetals, acetone derivatives, benzophenones and derivatives thereof and thyoxanthones.

According to the IPI (Tax on Manufacture) table, a ground polyethylene terephthalate (PET) bottle based hydroxylated adhesive corresponds to code NCM:35.06.99.00.

1. Hydroxylated adhesive composition, CHARACTERIZED by using as raw material a terephthalic base (A) and, in any mixing proportion, alcohol bases (B) and acid bases (C), having terminal hydroxyls within the range of 10 to 1,000 mg KOH/g.

2. Composition, according to claim 1, CHARACTERIZED in that, among the various possible formulations, it optionally comprises 55.49 g of terephthalic base, 18.48 g of alcohol base and 26.03 g of acid base, wherein the source of said terephthalic base is selected from ground, crushed or in any physical form PET bottles, reclaimed polyethylene terephthalate (PET) scrap of any kind and/or species and/or physical form, distillation residues from polyethylene terephthalate polimerization (oligomer solution), dicyclopentadiene, naphta (petroleum) cracking and distillation byproducts.

3. Composition, according to claims 1 and 2, CHARACTERIZED in that it further comprises acrylates and/or solvents, reactive or non reactive, as viscosity controlling agent for the composition.

4. Composition, according to claims 1 and 2, CHARACTERIZED in that it further comprises adding any proportion of isocyanate base by means of chemical reaction or physical mixture of said isocyanate base or prepolimers thereof, preferably adding 17 g for 560 g of hydroxylated adhesive.

5. Composition, according to claims 1 and 2, CHARACTERIZED in that it further comprises adding any proportion of acrylated base (E) by means of chemical reaction or physical mixture, preferably adding 14 g for 560 g of hydroxylated adhesive.

6. Composition, according to claim 5, CHARACTERIZED in that it comprises acylates and/or reactive solvents as viscosity controlling agents for the composition.

7. Composition, according to claim 5 or 6, CHARACTERIZED in that it is curable by ultraviolet radiation or electron beam.

8. Process for making a hydroxylated adhesive composition, CHARACTERIZED in that it comprises:
(i) reacting said terephthalic base with an alcohol base;
(ii) melting the mass in a pressurized or non pressurized reactor, at a temperature between 120 and 280° C., maintaining the molten mixture under agitation for 2 to 10 hours;
(iii) adjusting the terminal hydroxyl number from 10 to 1,000 mg KOH/g by adding an acid base, maintaining the temperature between 100 and 260° C.;
(iv) cooling the melted mass to a temperature between 100 and 220° C. so as to obtain a hydroxylated adhesive composition.

9. Process, according to claim 8, CHARACTERIZED in that said terephthalic base comes from ground, crushed or in any physical form PET bottles, reclaimed polyethylene terephthalate (PET) scrap of any kind and/or species and/or physical form, distillation residues from polyethylene terephthalate polimerization (oligomer solution), dicyclopentadiene, naphta (petroleum) cracking and distillation byproducts.

10. Process, according to claim 8, CHARACTERIZED in that said terephthalic bases may enter the reaction process ground, crushed or in any physical form.

11. Process, according to claim 8, CHARACTERIZED in that it further comprises optionally the step of adding to said hydroxylated adhesive composition an isocyanate base, by means of chemical reaction or physical mixture, or a mixture of isocyanate or urethane prepolymers, or blends thereof, wherein the exothermicity is controlled so as not to exceed 90° C., followed by heating the reactional mass to 45-170° C., until urethanization is completed, forming a urethanized hydroxylated adhesive.

12. Process, according to claim 11, CHARACTERIZED in that the reaction components can be mixed and/or reacted in any proportion.

13. Process, according to claim 11, CHARACTERIZED in that the viscosity adjustment is effected by adding acrylates, reactive solvents and non reactive solvents, in an amount sufficient to reach the desired viscosity for the final product.

14. Process, according to claim 8, CHARACTERIZED in that it comprises the step of adding to said hydroxylated adhesive composition acrylic or acrylated functional monomers, by means of chemical reaction or physical mixture thereof, wherein the temperature does not exceed 180° C., then, removing 98% of water, forming an acrylated hydroxylated adhesive.

15. Process, according to claim 14, CHARACTERIZED in that said reaction components can be mixed and/or reacted in any proportion.

16. Process, according to claim 15, CHARACTERIZED in that said viscosity adjustment is effected by adding acylates and reactive solvents, in an amount sufficient to reach the desired viscosity for the final acrylated hydroxylated adhesive composition.

17. Process, according to claim 14, CHARACTERIZED in that said acrylated hydroxylated adhesive composition can be cured by ultraviolet radiation, infrared or electron beam.
